(19) United States
(12) Patent Application Publication
(10) Pub. No.: US 2025/0228732 A1
(43) Pub. Date: Jul. 17, 2025

(54) SWINGING AND KNEADING MASSAGE MECHANISM

(71) Applicant: Kristin (Shenzhen) Technology Co., Ltd., Shenzhen (CN)

(72) Inventor: Mengting Tao, Pubei County (CN)

(21) Appl. No.: 18/415,473

(22) Filed: Jan. 17, 2024

(51) Int. Cl. A61H 7/00; A61H 15/00

(52) U.S. Cl. CPC A61H 7/007; A61H 15/0078

(57) ABSTRACT

A swinging and kneading massage mechanism includes an outer housing, a first massage head assembly, a second massage head assembly, an inner housing, a power assembly, and a transmission assembly. The power assembly is in driving connection to the transmission assembly which is in driving connection to the first and second massage head assemblies. Vertical sliding rails are symmetrically disposed on the inner housing. The driving arm is movably sleeved on the rotary shaft, and in driving connection to the second massage head assembly. The inclined wheel is fixedly disposed to the rotary shaft, and the driving ring is movably sleeved on the inclined wheel. The first massage head assembly is fixedly disposed on the driving ring, and a limiting shaft is integrally disposed on the driving ring. An eccentric disc is integrally disposed on the inclined wheel, and a connection ball is integrally disposed at the driving arm.

### TECHNICAL FIELD

The present disclosure relates to the technical field of massage mechanisms, and in particular to a swinging and kneading massage mechanism.

### BACKGROUND

People in modern cities live in a faster pace. Most people have to be buried in a large amount of work during the day, and have to take care of the children and do housework in the evening, which makes them do not have enough time to rest after a busy day. Day after day, many physical problems such as soreness and strain of bones and muscles caused by overwork occur in human bodies such as a neck and shoulders. If fatigue is not relieved after long time, irreversible consequences may occur, which has a large impact on the human bodies. Therefore, there are various tools such as massagers and massage chairs. People may massage themselves by using the massage devices, to promote blood circulation, relax the human body, and relieve fatigue.

An existing shoulder and neck massage mechanism massages the neck and shoulders by two groups of massage heads driven by a bidirectional motor. Because the massage heads of the existing movement have simple structures, tracks of the massage heads are relatively single, and stimulation is poor during massage.

Therefore, a swinging and kneading massage mechanism is provided to resolve the problems raised in the above.

### SUMMARY

An objective of the present disclosure is to provide a swinging and kneading massage mechanism, to resolve the problems raised in the background.

To achieve the above purpose, the present disclosure provides the following technical solution: A swinging and kneading massage mechanism includes an outer housing, a first massage head assembly, a second massage head assembly, an inner housing, a power assembly, and a transmission assembly. The power assembly is in driving connection to the transmission assembly. The transmission assembly is in driving connection to the first massage head assembly and the second massage head assembly.

Vertical sliding rails are symmetrically disposed on the inner housing.

The transmission assembly includes a gear set, a rotary shaft, a driving arm, a driving ring, a fixing cover, and an inclined wheel. The driving arm is movably sleeved on the rotary shaft, and the driving arm is in driving connection to the second massage head assembly. The inclined wheel is fixedly disposed to an upper end of the rotary shaft, and the driving ring is movably sleeved on the inclined wheel. The first massage head assembly is fixedly disposed on the driving ring, a limiting shaft is integrally disposed on a side surface of the driving ring, and the limiting shaft is vertically slidingly connected to the vertical sliding rail. An eccentric disc is integrally disposed on a lower surface of the inclined wheel, the eccentric disc is inserted into a circular groove provided at one end of the driving arm, and a connection ball is integrally disposed at the other end of the driving arm.

Preferably, the inner housing and a heat therapy assembly are disposed inside the outer housing.

Preferably, the power assembly includes a battery and a bidirectional motor, and output shafts at two ends of the bidirectional motor are worms.

Preferably, the gear set is formed by meshing a transmission gear with a transmission gear set, the transmission gear set is rotationally disposed inside the inner housing. The transmission gear set is formed by stacking a worm gear and a tooth gear that are coaxially disposed. The worm gear meshes with a worm, the tooth gear meshes with the transmission gear, the rotary shaft fixedly passes through the transmission gear, and the rotary shaft is rotationally connected to the inner housing.

Preferably, the fixing cover is fixedly disposed on the inclined wheel, a tilted ring groove is formed between the inclined wheel and the fixing cover. The tilted ring groove is movably sleeved on the driving ring, a plug is integrally disposed on the driving ring, a socket is disposed on the first massage head assembly, and the socket is plugged into the plug.

Preferably, a first swing arm is integrally on the socket, and a double-ball roller is disposed at an upper end of the first swing arm.

Preferably, the second massage head assembly includes a second swing arm, a massage ball is disposed at an upper end of the second swing arm, a spherical groove is provided on a side surface of the second swing arm, and the spherical groove is embedded and rotationally connected to the connection ball.

Preferably, a rotating shaft is disposed at a bottom of the second swing arm, and the rotating shaft is rotationally connected to the inner housing.

Compared with the prior art, the present disclosure has the following beneficial effects:

Through the transmission assembly, two massage heads are synchronously driven to massage a neck and shoulders. In addition, the transmission assembly includes the inclined wheel and the eccentric structure. Therefore, movement tracks of the two massage heads are variable, and stimulation is improved during massage. Due to a compact structure, a volume of the massage mechanism is saved. In addition, due to the heat therapy assembly and fitting with heating, blood circulation is promoted and muscles are relaxed during massage.

### BRIEF DESCRIPTION OF THE DRAWINGS

FIG. 1 is a schematic diagram of a structure of the present disclosure;

FIG. 2 is a schematic diagram of an internal structure of an outer housing of the present disclosure;

FIG. 3 is a top view of a rear side of FIG. 2 of the present disclosure;

FIG. 4 is a schematic diagram of an internal structure of an inner housing of the present disclosure;

FIG. 5 is a schematic diagram of a structure of a transmission assembly of the present disclosure; and

FIG. 6 is a bottom and side view of FIG. 5 of the present disclosure.

Reference numerals: 1: outer housing; 2: first massage head assembly; 21: double-ball roller; 22: first swing arm; 23: socket; 3: second massage head assembly; 31: second swing arm; 32: rotating shaft; 33: spherical groove; 4: heat therapy assembly; 5: transmission assembly; 51: transmission gear; 52: rotary shaft; 53: transmission gear set; 54: driving arm; 541: connection ball; 55: driving ring; 551: plug; 552: limiting shaft; 56: fixing cover; 57: inclined wheel; 571: eccentric disc; 6: inner housing; 61: vertical sliding rail; 7: power assembly; 71: bidirectional motor; 72: worm.

### DETAILED DESCRIPTION OF THE EMBODIMENTS

The technical solutions in embodiments of the present disclosure will be described below clearly and completely with reference to the accompanying drawings in embodiments of the present disclosure. Apparently, the described embodiments are merely some, rather than all of the embodiments of the present disclosure. All other embodiments obtained by a person of ordinary skill in the art based on embodiments of the present disclosure without creative efforts shall fall within the protection scope of the present disclosure.

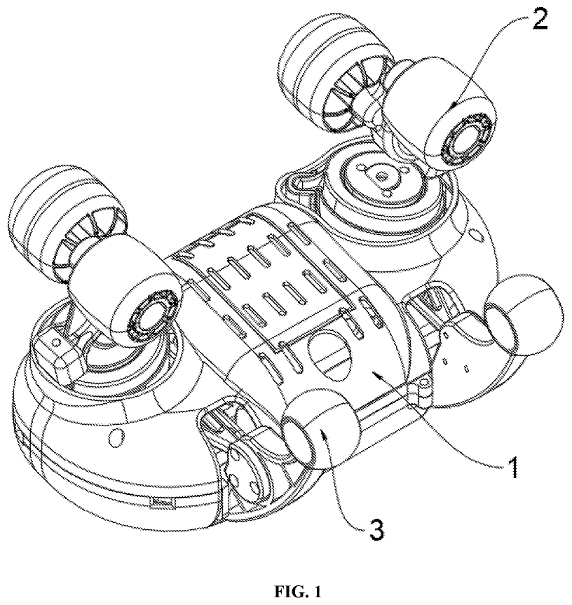

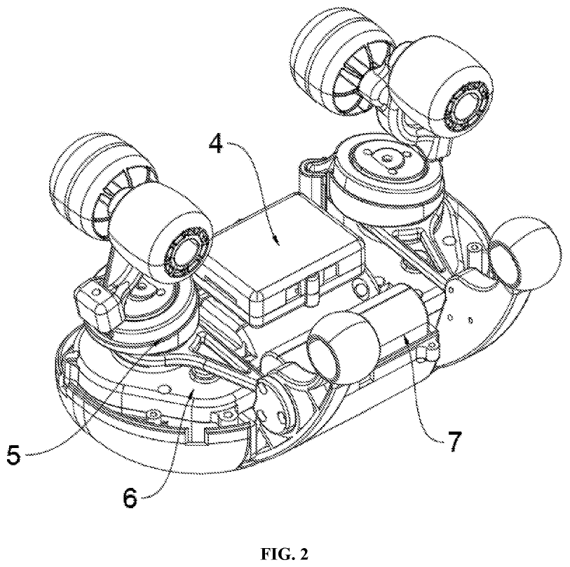

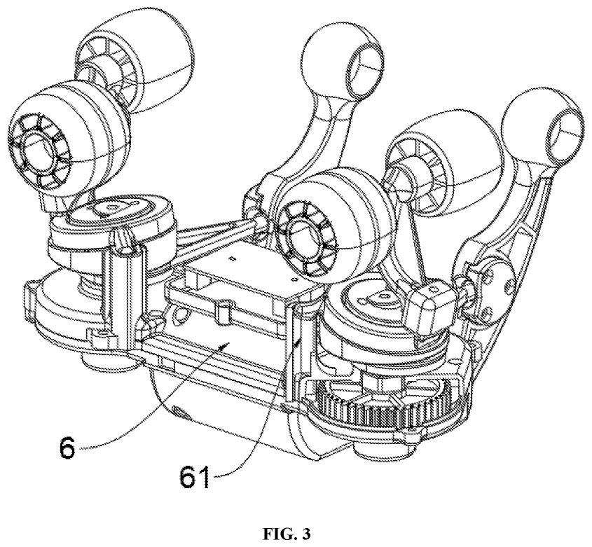

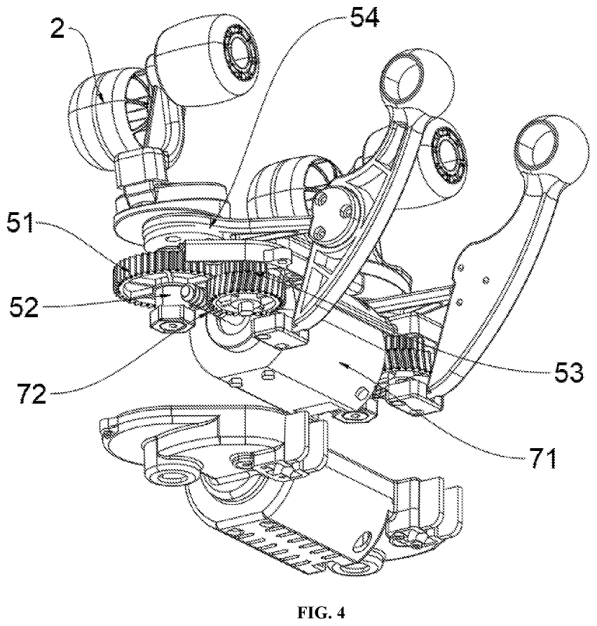

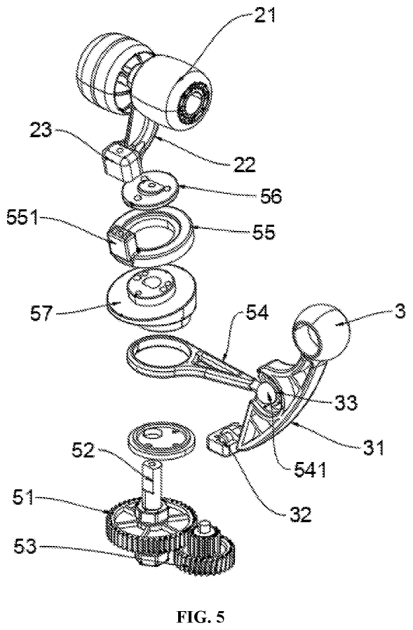

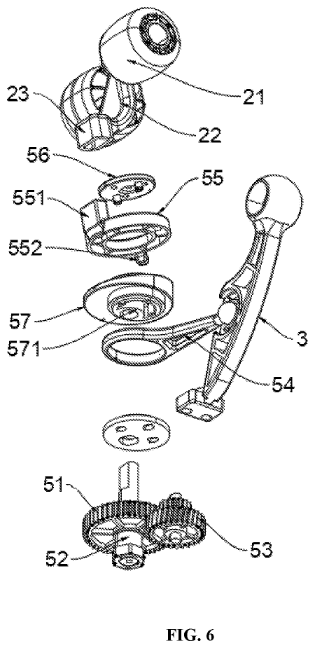

Referring to FIG. 1 to FIG. 6, the present disclosure provides a technical solution: A swinging and kneading massage mechanism includes an outer housing 1, a first massage head assembly 2, a second massage head assembly 3, an inner housing 6, a power assembly 7, and a transmission assembly 5. The inner housing 6 and a heat therapy assembly 4 are disposed inside the outer housing 1. The power assembly 7 and the transmission assembly 5 are disposed inside the inner housing 6.

The power assembly 7 is in driving connection to a transmission assembly 5. The transmission assembly 5 is in driving connection to the first massage head assembly 2 and the second massage head assembly 3.

The power assembly 7 includes a battery and a bidirectional motor 71, and output shafts at two ends of the bidirectional motor 71 are worms 72.

Vertical sliding rails 61 are symmetrically disposed on the inner housing 6.

The transmission assembly 5 includes a transmission gear 51, a rotary shaft 52, a transmission gear set 53, a driving arm 54, a driving ring 55, a fixing cover 56, and an inclined wheel 57. The transmission gear set 53 is rotationally disposed inside the inner housing 6. The transmission gear set 53 is formed by stacking a worm gear and a tooth gear that are coaxially disposed. The worm gear meshes with a worm 72, and the tooth gear meshes with the transmission gear 51.

The rotary shaft 52 fixedly passes through the transmission gear 51, and the rotary shaft 52 is rotationally connected to the inner housing 6. The driving arm 54 is movably sleeved on the rotary shaft 52, and the driving arm 54 is in driving connection to the second massage head assembly 3.

The inclined wheel 57 is fixedly disposed to an upper end of the rotary shaft 52. The fixing cover 56 is fixedly disposed on the inclined wheel 57, and a tilted ring groove is formed between the inclined wheel 57 and the fixing cover 56. The tilted ring groove is movably sleeved on the driving ring 55. The first massage head assembly 2 is fixedly disposed on the driving ring 55.

A plug 551 is integrally disposed on the driving ring 55, a socket 23 is disposed on the first massage head assembly 2, and the socket 23 is plugged into the plug 551.

A limiting shaft 552 is integrally disposed on a side surface of the driving ring 55, and the limiting shaft 552 is vertically slidingly connected to the vertical sliding rail 61.

A first swing arm 22 is integrally on the socket 23, and a double-ball roller 21 is disposed at an upper end of the first swing arm 22.

An eccentric disc 571 is integrally disposed on a lower surface of the inclined wheel 57, and the eccentric disc 571 is inserted into a circular groove provided at one end of the driving arm 54. When the inclined wheel 57 rotates, the eccentric disc 571 drives the driving arm 54 to move eccentrically. A connection ball 541 is integrally disposed at the other end of the driving arm 54.

The second massage head assembly 3 includes a second swing arm 31, a massage ball is disposed at an upper end of the second swing arm 31, a spherical groove 33 is provided on a side surface of the second swing arm 31, and the spherical groove 33 is embedded and rotationally connected to the connection ball 541.

A rotating shaft 32 is disposed at a bottom of the second swing arm 31, and the rotating shaft 32 is rotationally connected to the inner housing 6.

The bidirectional motor 71 of the power assembly 7 is started, to drive the worms 72 on two sides to rotate. This enables the transmission gear set 53 to drive the transmission gear 51 to rotate, and enables the rotary shaft 52 to rotate. The rotary shaft 52 synchronously drives the inclined wheel 57 to rotate. Due to an inclined design of the inclined wheel 57, the driving ring 55 on the inclined wheel 57 swings in a circumference. In addition, the limiting shaft 552 is fitted with the vertical sliding rail 61, to drive the first massage head assembly 2 to swing in a ring, and perform swinging and kneading massage on a human body.

Synchronously, the eccentric disc 571 of the inclined wheel 57 drives the driving arm 54 to reciprocate on the rotary shaft 52, to pull the second swing arm 31 to reciprocate on rotating shaft 32 as an axis, and enable the massage ball at the upper end to perform a roller-pressing massage on the human body.

The content not described in detail in this specification belongs to the prior art well known to those skilled in the art.

Although embodiments of the present disclosure have been illustrated and described, those of ordinary skill in the art can understand that various changes, modifications, replacements, and alterations may be made to these embodiments without departing from the principle and tenet of the present disclosure, and the scope of the present disclosure is defined by the claims and equivalents thereof.

What is claimed is:

1. A swinging and kneading massage mechanism, comprising: an outer housing (1), a first massage head assembly (2), a second massage head assembly (3), an inner housing (6), a power assembly (7), and a transmission assembly (5), wherein the power assembly (7) is in driving connection to the transmission assembly (5), and the transmission assembly (5) is in driving connection to the first massage head assembly (2) and the second massage head assembly (3);
vertical sliding rails (61) are symmetrically disposed on the inner housing (6); and
the transmission assembly (5) comprises a gear set, a rotary shaft (52), a driving arm (54), a driving ring (55), a fixing cover (56), and an inclined wheel (57), the driving arm (54) is movably sleeved on the rotary shaft (52), the driving arm (54) is in driving connection to the second massage head assembly (3), the inclined wheel (57) is fixedly disposed to an upper end of the rotary shaft (52), the driving ring (55) is movably sleeved on the inclined wheel (57), the first massage head assembly (2) is fixedly disposed on the driving ring (55), a limiting shaft (552) is integrally disposed on a side surface of the driving ring (55), the limiting shaft (552) is vertically slidingly connected to the vertical sliding rail (61), an eccentric disc (571) is integrally disposed on a lower surface of the inclined wheel (57), the eccentric disc (571) is inserted into a circular groove provided at one end of the driving arm (54), and a connection ball (541) is integrally disposed at the other end of the driving arm (54).

2. The swinging and kneading massage mechanism according to claim 1, wherein the inner housing (6) and a heat therapy assembly (4) are disposed inside the outer housing (1).

3. The swinging and kneading massage mechanism according to claim 1, wherein the power assembly (7) comprises a battery and a bidirectional motor (71), and output shafts at two ends of the bidirectional motor (71) are worms (72).

4. The swinging and kneading massage mechanism according to claim 1, wherein the gear set is formed by meshing a transmission gear (51) with a transmission gear set (53), the transmission gear set (53) is rotationally disposed inside the inner housing (6), the transmission gear set (53) is formed by stacking a worm gear and a tooth gear that are coaxially disposed, the worm gear meshes with a worm (72), the tooth gear meshes with the transmission gear (51), the rotary shaft (52) fixedly passes through the transmission gear (51), and the rotary shaft (52) is rotationally connected to the inner housing (6).

5. The swinging and kneading massage mechanism according to claim 1, wherein the fixing cover (56) is fixedly disposed on the inclined wheel (57), a tilted ring groove is formed between the inclined wheel (57) and the fixing cover (56), the tilted ring groove is movably sleeved on the driving ring (55), a plug (551) is integrally disposed on the driving ring (55), a socket (23) is disposed on the first massage head assembly (2), and the socket (23) is plugged into the plug (551).

6. The swinging and kneading massage mechanism according to claim 5, wherein a first swing arm (22) is integrally disposed on the socket (23), and a double-ball roller (21) is disposed at an upper end of the first swing arm (22).

7. The swinging and kneading massage mechanism according to claim 1, wherein the second massage head assembly (3) comprises a second swing arm (31), a massage ball is disposed at an upper end of the second swing arm (31), a spherical groove (33) is provided on a side surface of the second swing arm (31), and the spherical groove (33) is embedded and rotationally connected to the connection ball (541).

8. The swinging and kneading massage mechanism according to claim 7, wherein a rotating shaft (32) is disposed at a bottom of the second swing arm (31), and the rotating shaft (32) is rotationally connected to the inner housing (6).
